(19) United States
(12) Patent Application Publication
(10) Pub. No.: US 2010/0177687 A1
(43) Pub. Date: Jul. 15, 2010

(54) Communication method using statistical multiplexing and apparatus for performing the same

(75) Inventors: Dan Keun Sung, Daejeon (KR); Seong Hwan Kim, Seoul (KR); Su Min Kim, Daejeon (KR); Su Ha Yoon, Daejeon (KR)

Correspondence Address: BACON & THOMAS, PLLC, 625 SLATERS LANE, FOURTH FLOOR, ALEXANDRIA, VA, 22314-1176, US

(73) Assignee: KOREA ADVANCED INSTITUTE OF SCIENCE AND TECHNOLOGY, Daejon (KR)

(21) Appl. No.: 12/591,859

(22) Filed: Dec. 3, 2009

(30) Foreign Application Priority Data
Jan. 14, 2009 (KR) 10-2009-0002893

(51) Int. Cl. H04W 40/00

(52) U.S. Cl. 370/328

(57) ABSTRACT

A communication method using statistical multiplexing in which pre-determined hopping patterns are respectively allocated to two or more users who communicate with a base station using orthogonal resources, the communication method includes: receiving a transmission signal transmitted using the orthogonal resources; and acquiring data from the received transmission signal, wherein each of the users belongs to one of two or more groups and the pre-determined hopping patterns are allocated to prevent collision between the users belonging to the same group.

### CROSS-REFERENCE(S) TO RELATED APPLICATION(S)

The present invention claims priority of Korean Patent Application No. 10-2009-0002893, filed on Jan. 14, 2009, which is incorporated herein by reference.

### FIELD OF THE INVENTION

The present invention relates to a communication method using statistical multiplexing and an apparatus for performing the same, and, more particularly, to a communication method capable of resolving signal collisions in statistical multiplexing and an apparatus for performing the same.

### BACKGROUND OF THE INVENTION

In wireless communications, since the amount of resources used for communications is limited, it is necessary to efficiently utilize this limited amount of resource in order to support the wireless communications. To this end, there have been various multiplexing techniques. For example, in a code division multiple access (CDMA) technique, a plurality of orthogonal codes are allocated to respective users. A transmitter modulates (or encodes) signals using the allocated orthogonal codes to transmit the modulated signals and a receiver demodulates (or decodes) the transmitted signals using the same orthogonal codes to recover the original signal. As such, the multiplexing method using the orthogonality of codes may be applied to various resources such as time, frequency, phase, and the like.

Meanwhile, the multiplexing using the allocation of the orthogonal resources may cause inefficiency. For example, when one user establishes a communication link but does not transmit data through a channel during the inactive period, the resources allocated to the user are not used but wasted. Thus, statistical multiplexing techniques in which one resource is not allocated in a dedicated manner to one user have been proposed, and one of them is an orthogonal resource hopping multiplexing (ORHM). Using the ORHM, hopping patterns for the resources are pre-allocated to respective users and the users continue to change (i.e., hop) the resources to be used depending on the hopping patterns. By doing so, the resources pre-allocated to inactive users may be used by other users as predetermined time lapses, thereby preventing waste of the resources. Moreover, an application of ORHM to the uplink is referred to as orthogonal resource hoping multiple access (ORHMA).

In the statistical multiplexing such as ORHM and ORHMA, the probability that the same resource is allocated to two or more users at the same time, namely, the probability of resource collision among users is not zero. Thus, a measure for recovering the original symbol despite the resource collision is needed. For this recovery, a multiuser detector (MUD) such as a maximum likelihood multiuser detector (ML MUD) can be used.

In general, the MUD recovers a symbol from a collided signal based on a channel coefficient of a communication channel used by a user. The channel coefficient is obtained by monitoring the status of a channel by communicating pilot signals in addition to data signals. However, when the collision between users occurs in the ORHM or the ORHMA system, the pilot signals may collide with each other. In this case, it is impossible to obtain the channel coefficient from the pilot signals, so that the symbol cannot be recovered from the collided signal even by the MUD. Therefore, a technology for preventing the pilot signals from colliding with each other is required.

### SUMMARY OF THE INVENTION

In view of the above, the present invention provides a method of resolving collisions between pilot signals and determining the channel coefficient in a system using statistical multiplexing and an apparatus for performing the same.

In accordance with a first aspect of the present invention, there is provided a communication method using statistical multiplexing in which pre-determined hopping patterns are respectively allocated to two or more users who communicate with a base station using orthogonal resources, the communication method including:

receiving a transmission signal transmitted using the orthogonal resources; and

acquiring data from the received transmission signals,

wherein each of the users belongs to one of two or more groups and the pre-determined hopping patterns are pre-allocated to prevent collisions between the users belonging to the same group.

In accordance with a second aspect of the present invention, there is provided a communication method using statistical multiplexing in which pre-determined hopping patterns are respectively allocated to two or more users who communicate with a base station using orthogonal resources, the communication method including:

determining the orthogonal resources to be used depending on the pre-determined hopping patterns;

determining pilot signals to be allocated to the users; and

transmitting transmission signals including the pilot signals using the determined orthogonal resources,

wherein each of the users belongs to one of two or more groups and the pre-determined hopping patterns are allocated to prevent collision between the users belonging to the same group.

### BRIEF DESCRIPTION OF THE DRAWINGS

The above features of the present invention will become apparent from the following description of embodiments given in conjunction with the accompanying drawings, in which:

FIG. 1 is a view illustrating a method of allocating resources in accordance with embodiments of the present invention;

FIG. 2 is a view illustrating an architecture of multiple resource blocks to be included in an allocated resource area composed of several time units and subcarriers;

FIGS. 3A and 3B are views illustrating resource elements included in a single resource block;

FIG. 4 is a flowchart illustrating a method of detecting data of a user in a resource block in accordance with a first embodiment of the present invention;

FIG. 5 is a flowchart illustrating a method of detecting data of a user in a resource block in accordance with a second embodiment of the present invention;

FIG. 6 is a view illustrating the architecture of a frame to be transmitted at a specific time;

FIG. 7 is a flowchart illustrating a method of transmitting a signal of a user in accordance with a second embodiment of the present invention; and

FIGS. 8A and 8B are block diagrams illustrating a communication apparatus in accordance with the embodiments of the present invention.

### DETAILED DESCRIPTION OF THE EMBODIMENTS

Hereinafter, exemplary embodiments of the present invention will be described in detail with reference to the accompanying drawings, but the present invention is not limited thereto.

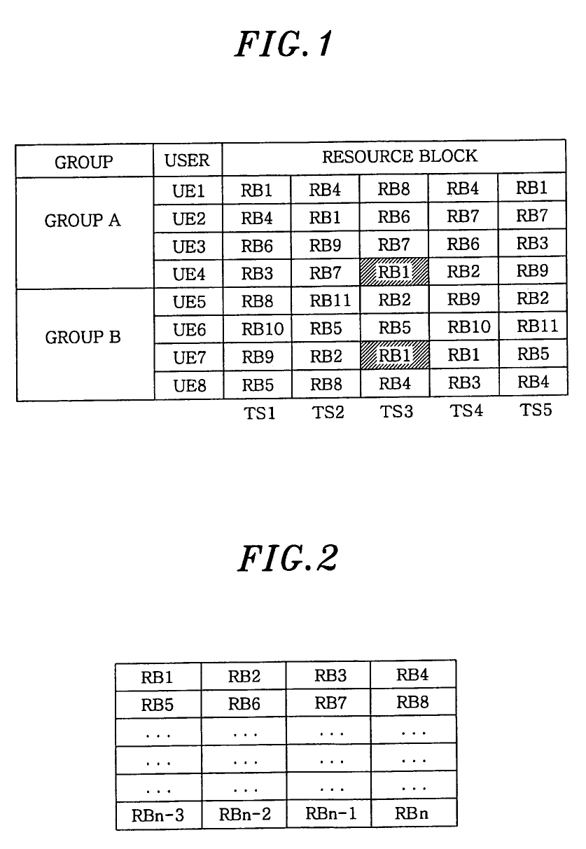

FIG. 1 shows a method of allocating resources in accordance with embodiments of the present invention. As illustrated in FIG. 1, a hopping pattern for use of orthogonal resources is pre-allocated to a user. The orthogonal resources are orthogonal with each other and do not interfere in different resources. For example, when different codes are multiplied with each other to become zero, the different codes are referred to as orthogonal codes. Meanwhile, the term ‘user’ is not limited to those who take part in communications but include apparatuses used in communications.

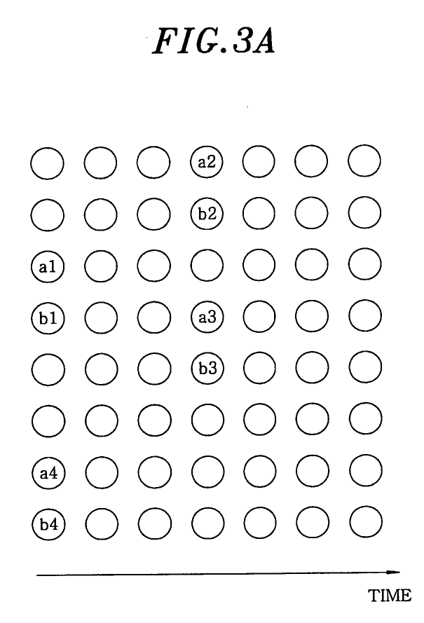

At every time slot, a predetermined resource block (RB) is allocated to the user. In more detail, a signal which uses a designated resource block illustrated in FIG. 2 is transmitted at every time slot, which is referred to as a “frame.” A single frame is the whole allocated resource area to users. A frame is shared by a plurality of users and consists of a plurality of resource blocks and the respective resource block is allocated to a single user. The resource block indicates a resource allocated to the user among communication resources such as frequency, orthogonal code, phase, and time. Such a resource block can be part of the resources in a physical point of view or part of a resource space in a conceptual point of view. It is assumed that all users are allocated with the same sized resource block. Each of the users is not permanently allocated with a single resource block but uses a different resource at every time slot depending on a pre-determined hopping pattern. For example, referring to FIG. 1 again, user UE1 uses a resource block RB1 at time slot TS1 but uses a resource block RB4 at time slot TS2. A single resource block may be allocated to two or more users at the same time and, thus, a larger number of users than the number of resource blocks may be serviced.

Each of the users belongs to a group. Users belonging to one group are allocated with hopping patterns to prevent a collision between the users. For example, hopping patterns are allocated to users, UE1 to UE4, belonging to group A such that the users use different resource blocks at the same time slot. On the other hand, a collision may occur between users belonging to different groups. For example, since both of users, UE4 and UE7, who belong to groups A and B respectively, use the resource block RB1 at time slot TS3, a resource collision occurs between the users.

When users collide with each other, the collided signal is recovered using MUD, for example, ML MUD. In this case, a signal received from a base station may be expressed by the following equation.

$${y}_{i} = {h}_{i} \cdot \sqrt{{P}_{i}} {s}_{i} + {\sum }_{l = 1 , l \neq i}^{L} {h}_{l} \cdot \sqrt{{P}_{l}} {s}_{l} + {n}_{i} , \qquad [ Equation 1 ]$$

where yᵢ is the received signal, hᵢ is the channel coefficient of the i-th user, Pᵢ is the signal power of the i-th user, sᵢ is the symbol of the i-th user, nᵢ is the noise, and L is the number of collided users. That is, equation 1 represents that a sum of symbols of several users and noise are transmitted together when there is a collision.

As seen from equation 1, the channel coefficient h₁ must be known in order to recover the symbol sᵢ from the received signal yᵢ, and the channel coefficient hᵢ may be obtained based on a pilot signal within the signal yᵢ. The pilot signal enables the receiver to check the channel status and may not contain substantial data. When a user receives the pilot signal without collision through a channel, the channel coefficient of the channel can be obtained and, from this, collided signals can be recovered. The pilot signal may be arranged at a predetermined position within a signal. Here, the pilot signal position indicates the position within a transmission signal, which may be distinguished by coordinates such as certain codes, time, space, frequency, and phase. The predetermined position indicates the codes, time, space, frequency, or phase, which is predefined, within a signal transmitted by a user so that the receiver can estimate the properties of the transmitted signal, including the channel characteristics from the pilot signal. For example, the pilot signal at the predetermined position may be a signal transmitted at a preset time and a preset frequency.

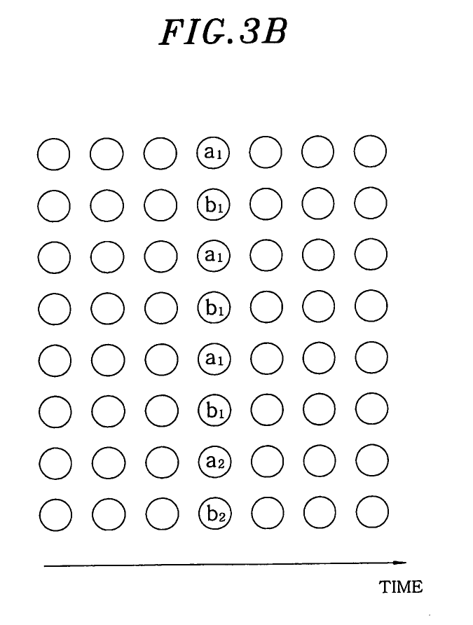

Different pilot signals may be located orthogonally in the same resource block to prevent a collision between the pilot signals. In the embodiments of the present invention, the position of the pilot signal may be differently determined according to groups. For example, users belonging to different groups transmit different pilot signals in different positions in the allocated resource blocks. This will be described with reference to FIGS. 3A and 3B.

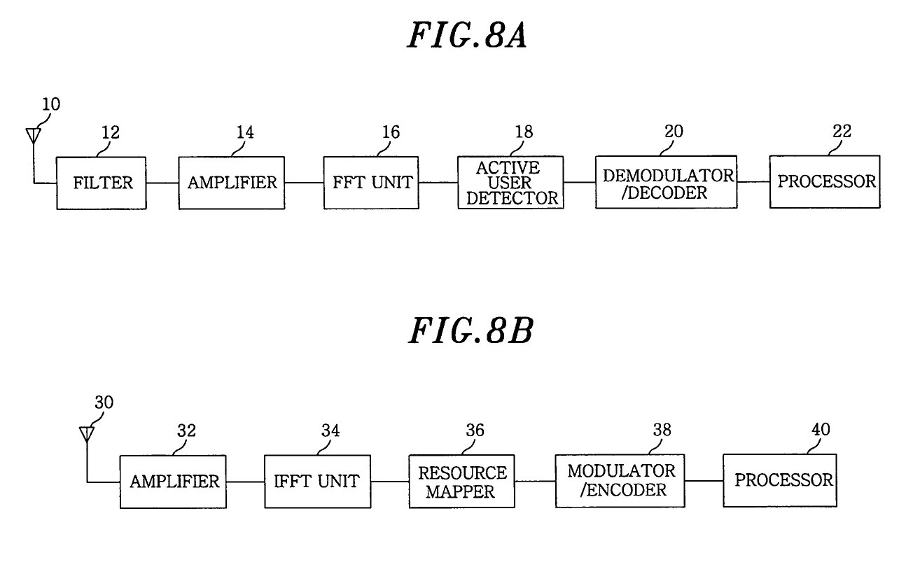

FIGS. 3A and 3B show the resource elements in a single resource block, as part of the resource block of an orthogonal frequency division multiplexing (OFDM) system. The resource element indicates a unit of transmission resource with consideration of both of subcarrier and time. When the transmission times of the resource blocks are different from each other, the same subcarriers can be designated to different resource blocks. In FIGS. 3A and 3B, 8 subcarriers and 7 OFDM symbols are used in a single resource block as an example, and, thus, this resource block consists of a total 56 resource elements. This is, however, an illustrative example and a different number of resource elements may include one resource block. Referring to FIG. 3A, group A users (See FIG. 1) transmit a pilot signal at positions a1 to a4, whereas group B users (See FIG. 1) transmit a pilot signal at positions b1 to b4. Referring to FIG. 3B, group A users transmit a pilot signal at positions a1 to a2, whereas group B users transmit a pilot signal at positions b1 to b2. As such, since the groups A and B users transmit pilot signals at different positions, a collision does not occur between the pilot signals even when a user UE1 belonging to the group A has a resource collision with a user UE7 belonging to the group B. Thus, it is possible to obtain a correct channel coefficient from the pilot signals. Moreover, when two or more groups are used and pilot signals are positioned at different resource elements not according to users but according to groups, the number of required resource elements for pilot signals may be reduced.

Although two groups are described with reference to FIGS. 3A and 3B, but this is only an illustrative example and the number of groups may be determined according to types of data to be communicated, that is, types of services. This is because traffic patterns and activity of a corresponding channel are different according to types of services in uplink. For example, since voice traffic has a channel activity of 0.4 to 0.5, in order to sufficiently accommodate the voice traffic in the capacity of the channel, it is required that the voice traffic is divided into two groups before statistical multiplexing is performed. On the other hand, since data communication such as internet has a channel activity of about 0.1, although the number of groups to be multiplexed is set to about 4 to 5 such that a plurality of groups perform the transmission, the capacity of the channel can accommodate the traffic in data communication. As described, a gain of statistical multiplexing may be improved by adjusting the number of groups according to types of services.

Meanwhile, the groups may be divided according to types of the services or each of the groups may include various types of the services. When a user is set to a specific group, traffic load is considered in order to balance the traffic load between groups. In other words, users are distributed in every group in consideration of balance of the traffic load. For example, a service rate of i-th user in g-th group may be represented as S_{g,i}. At this time, traffic load of g-th group may be defined as follows:

$${\sum }_{i = 1}^{{N}_{g}} {S}_{g , i} ,$$

Where N_{g} is the number of users in g-th group.

In order to make the traffic load be equal in every group, the following equation 2 needs to be satisfied when users are distributed in every group.

$${\sum }_{i = 1}^{{N}_{1}} {S}_{1 , i} \approx {\sum }_{i = 1}^{{N}_{2}} {S}_{2 , i} \approx … \approx {\sum }_{i = 1}^{{N}_{g}} {S}_{g , i} \qquad [ Equation 2 ]$$

Using the above-mentioned method, signals may be transmitted and received and the corresponding symbols can be detected from the received signals. Hereinafter, a method of transmitting and receiving signals in accordance with the embodiments of the present invention will be described. The following transmission and reception methods will be mainly described in association with transmission and reception of a single resource block, and it should be noted that the method in these embodiments may be repeatedly performed for transmission and reception of every resource block belonging to a single frame.

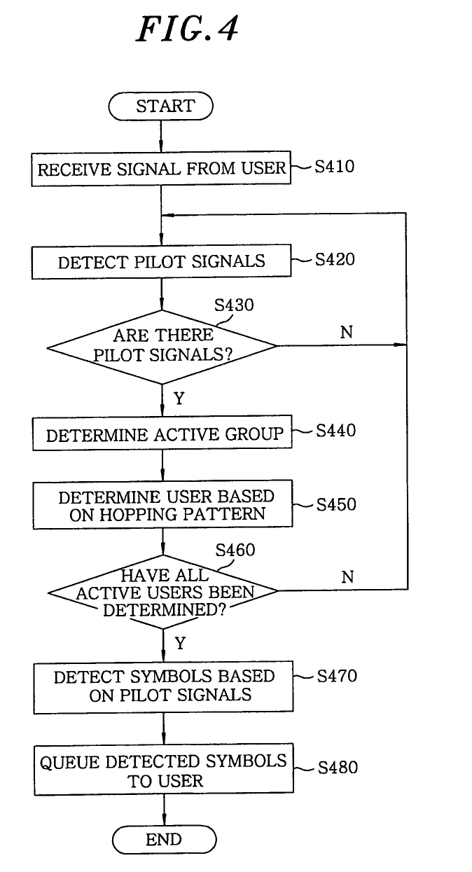

FIG. 4 is a flowchart illustrating a method of receiving a signal of a specific resource block in a frame in accordance with a first embodiment of the present invention. Referring to FIG. 4, first, synchronized frames transmitted from multiple users are received in a time slot and the receiver starts to detect data from the first resource block in the frame in step S410. Next, the pilot signals of a specific group within a specific resource block are detected at a predetermined position in step S420. The pilot signals are transmitted through specific resource elements. Whether or not there exist the pilot signals in the received signal is determined based on the received power of the pilot signals in step S430. In other words, when the received power of the signal extracted at a predetermined position is equal to or higher than a predetermined threshold, it is determined that there exist pilot signals. For example, when the received power of the pilot signals a1, a2, a3, and a4 shown in FIG. 3 are equal to or higher than the threshold, it is determined that there exist pilot signals for Group A. On the contrary, when it is determined that there exists no pilot signal, that is, when the received power of the extracted signal is lower than the threshold, the process returns to the step S420, so that another pilot signal is detected at a next predetermined position.

When it is determined that there are pilot signals, an active group, i.e., a group to which a user sending the signal belongs is determined in step S440. As described above, the positions where pilot signals are transmitted are differently determined according to groups and a collision does not occur between users belonging to the same group. When there exist pilot signals, since all users who can possibly transmit the pilot signals belong to the same group, it is assured that the detected pilot signal is received without collision. Thus, when a group to which the detected pilot signals is allocated is determined, the active group may be determined.

Next, a user who has transmitted the signal is determined among the users belonging to the active group in step S450. As described above, since there is no collision between users belonging to the same group, the number of users who communicates using a specific orthogonal resource block at a specific time is only one in each group. Since each user uses the resource blocks according to the hopping pattern, it is possible to determine a user who has transmitted a signal currently being communicated using the resource block allocated based on a pre-determined hopping pattern between the base station and the user.

Next, it is checked whether all active users belonging to other groups and using the same resource block have been determined in step S460. If all active users have not been detected, the process returns to the step S420. If all active users using the resource block have been determined, the symbols transmitted by the users are detected using the pilot signals in step S470. Specifically, first the channel coefficients are determined from the pilot signals and the symbols are detected using log-likelihood ratio (LLR) calculation. The following equation 3 expresses the LLR calculation when the collided users use binary phase shift keying (BPSK) modulation.

$$Λ ( {s}_{i} ) = log \frac{{\sum }_{m = 1}^{{2}^{L - 1}} exp \{ - \frac{{‖ {y}_{i} - {b}_{+ 1 , m} ‖}^{2}}{2 {σ}^{2}} \}}{{\sum }_{m = 1}^{{2}^{L - 1}} exp \{ - \frac{{‖ {y}_{i} - {b}_{- 1 , m} ‖}^{2}}{2 {σ}^{2}} \}} , \\ {\hat{s}}_{i , k} = \{ \begin{matrix}1 & Λ ( {s}_{i} ) > 1 \\ - 1 & Λ ( {s}_{i} ) \leq 1 ,\end{matrix} \qquad [ Equation 3 ]$$

where Λ(sᵢ) is the LLR value for sᵢ, b_{+1,m} and b_{-1,m} represent the realization of symbol vectors conditionally sᵢ=+1 and sᵢ=−1, respectively. When users use higher modulation schemes, equation 2 can be easily extended. In step S480, the detected symbols are queued as data transmitted by the corresponding user. The procedure of FIG. 4 repeats until the data of the last resource block in the frame is detected.

As described above, since there is no collision of the pilot signal, it is easy to obtain the channel coefficient and to detect the symbols using the pilot signal. Moreover, users may be identified using only the pilot signal and the pre-determined hopping pattern without adding an additional signal for the identification of users.

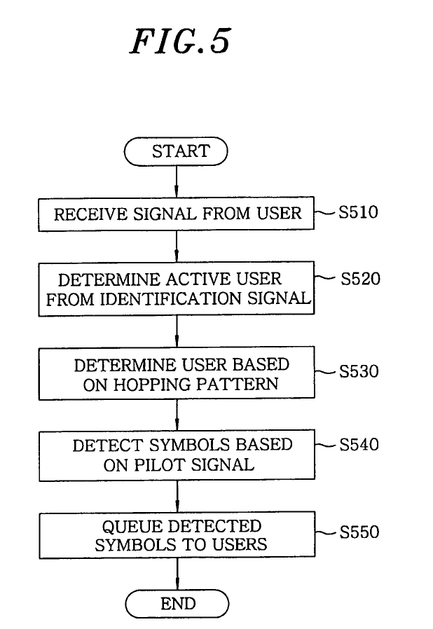

However, when the active group is determined based on the received power of pilot signals, an error may occur due to noise such as thermal noise in determining whether there are pilot signals and, thus, it is difficult to correctly identify the user. Therefore, in a second embodiment of the present invention, an identification signal is used to identify a user and this will be described with reference to FIG. 5.

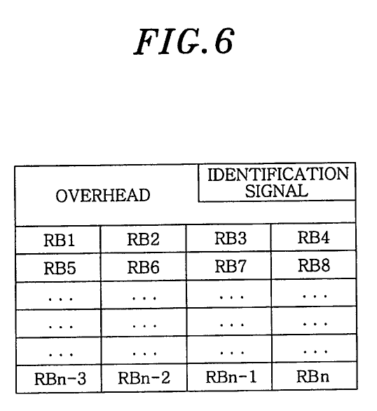

Referring to FIG. 5, synchronized frames transmitted from multiple users are received in a time slot and the receiver starts to detect data from the first resource block in the frame in step S510. In this case, the received signal contains an identification signal allocated to each user. For example, the identification signal may be an orthogonal code contained in the overhead of the transmitted signal, i.e., signaling overhead. Here, the orthogonal code is referred to as a code in which when different codes are multiplied the result value becomes zero. Specifically, when a signal having a frame structure illustrated in FIG. 6 is transmitted at a specific time, the identification signal may be transmitted using an identification signal region within a signaling overhead of the frame.

Next, in step S520, an active user, i.e., a user who transmits data is determined based on the identification signal. For example, when a specific identification signal is detected in an identification signal region within a transmitted frame, it is possible to determine the user who is allocated with the identification signal as an active user. When active users are determined, the users, among the active users, who are allocated with the corresponding resource block are identified based on the pre-determined hopping pattern in step S530. By doing so, it is possible to determine the users who have transmitted the signal using the corresponding resource block.

When the identification signal is contained in the overhead of the signal to be transmitted, the identification signal may be differently allocated to a different user. The signaling overhead contains information on a single frame and the single frame, as illustrated in FIG. 6, may contain a plurality of resource blocks. In other words, only one identification signal is transmitted with respected to several resource blocks. Thus, since two or more users belonging to the same group within a signal frame may transmit signals, every user has to be allocated with a separated identification signal so as to determine the active users.

When the users who have transmitted signals on the resource block are determined, the pilot signals contained in the received signal are detected and the symbols transmitted from the users are detected using the pilot signal in step S540. The channel coefficient is determined from the pilot signal and the symbols may be detected from the equation 2, as in the first embodiment of the present invention. Then, the symbols detected in step S550 are queued as the data transmitted by the corresponding user. The procedure of FIG. 5 repeats until the data of the last resource block in the frame is detected. However the step S520 can be omitted since the active users in the frame are found in the first procedure.

Since the active user is determined using the identification signal, it is possible to correctly determine the corresponding user even when the determination on whether there is a pilot signal is incorrect due to noise. Furthermore, since the identification signal is contained in the overhead, the amount of calculation required to detect the identification signal may be reduced.

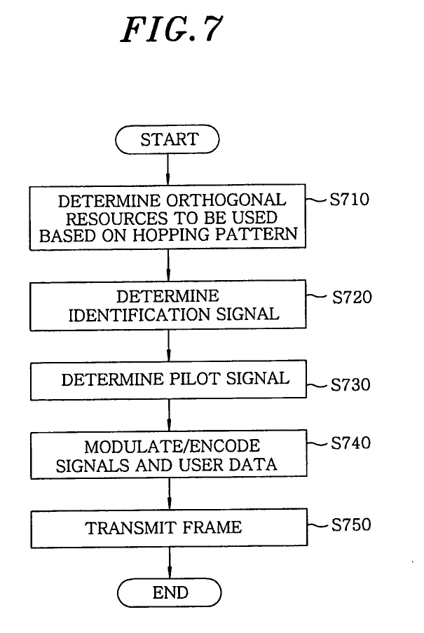

Next, a signal transmission method in accordance with the second embodiment of the present invention will be described with reference to FIG. 7.

First, the orthogonal resources to be used are determined based on the hopping pattern in step S710. Since the hopping patterns to be used are assigned to respective transmitters, the transmitter selects an orthogonal resource block allocated to itself at each time slot based on the hopping pattern when transmitting a signal. Each of users belongs to a single group and the hopping pattern is allocated not to cause a collision between the users who belong to the same group.

Next, an identification signal to be used for the transmission is determined in step S720. The identification signal enables the receiver to identify an active user and may be differently allocated to every user. The identification signal may be assigned with an orthogonal code. In the first embodiment of the present invention, the step S720 may be omitted and in this case, the receiver may determine the active group through the pilot signal to be described later without using the identification signal.

In step S730, pilot signals to be allocated to users are determined. The pilot signals enable the receiver to check the channel status and may do not contain real date. The pilot signal is contained in a predetermined position within the transmission signal not to cause a collision of the pilot signals between different groups. The predetermined positions may be different in every group. Since there is no collision between users belonging to the same group and users belonging to different groups transmit the pilot signals at different positions, there is no collision of the pilot signals. The pilot signals may be arranged in one or more subcarriers.

In step S740, the determined identification signals and pilot signals are modulated and/or encoded so that they are included in the transmission signal. In addition, user data are also modulated and/or encoded to be included in the transmission signal. This process may be performed using the orthogonal resources determined in step S710. For example, the signals may be encoded using the orthogonal codes. As another example, signals may be converted to be suitable for transmission through various modulations such as frequency modulation, phase modulation, amplitude modulation, and the like. The transmission signal including the identification signal and pilot signal is transmitted in step S750.

By transmitting a signal through the above-described process, a receiver receives a pilot signal without collision to check the channel status and uses the pilot signal and/or an identification signal together with a hopping pattern so that the user who has transmitted the signal may be determined.

A communication apparatus for performing communication method in accordance with the present invention will be described with reference to FIGS. 8A and 8B.

FIG. 8A shows a receiver apparatus in accordance with the embodiments of the present invention. The receiver apparatus includes an antenna 10 for capturing wireless signals. The signals captured by the antenna 10 are transmitted to a filter 12 such that noise is removed and only the signals in the required band are extracted. The filtered signals are delivered to an amplifier 14. The amplifier 14 amplifies the delivered signal into a level suitable for signal processing. The filter 12 may include various filters such as a band selection filter, a channel selection filter, an image removal filter, and the like, and the amplifier may be provided between filters to easily process the signal. The amplified signals are transformed from time-domain signal to frequency-domain signal in FFT (fast Fourier transform) unit 16. Thereafter, the active user detector 18 checks the power of pilot signals of each group in a specific resource block. If a specific resource block is used by a group, an active user included in the group is found by referring to the pre-determined hopping pattern. If an identification signal is used, the identification of a specific user is detected to determine the active user.

The demodulator/decoder 20 may demodulate the signals modulated in various ways such as frequency modulation, phase modulation, amplitude modulation and the like to extract the desired signals. The demodulator/decoder 20 may decode signals encoded with orthogonal codes to extract the desired signals. That is, the signals modulated and encoded with the orthogonal codes are recovered by the demodulator/decoder 20. At this time, user data are also demodulated and/or decoded by the demodulator/decoder 20. Next, a processor 22 may recover the symbols by performing a communication method same as described with reference to FIG. 4 or 5 based on the recovered signal. The processor 22 may recover the symbols independently or by controlling the demodulator/decoder 20.

FIG. 8B shows a transmitter apparatus in accordance with the embodiments of the present invention. The transmitter apparatus includes a processor 40. The processor 40 may perform a communication method same as described with reference to FIG. 7. The processor 40 may modulate and/or encode an identification signal and a pilot signal independently or by controlling a modulator/encoder 38, so that the modulated and/or encoded identification signal and pilot signal are included in a transmission signal. At this time, the user data are also modulated and/or encoded by the processor 40 or the modulator/encoder 38. A resource mapper 36 maps the modulated data and pilot signals of a specific user into a specific resource block according to the pre-determined hopping pattern of the user. If an identification signal is used, the modulated data and pilot signals are mapped into an identification signal region in the frame. An IFFT (inverse fast Fourier transform) unit 34 transforms frequency domain signal into the time domain signal by using IFFT and cyclic prefix is added to the head of the OFDM time domain signal. The transmission signal is amplified into a level suitable for transmission by an amplifier 32. The operation of the demodulator/decoder 20 at the receiver corresponds to the inverse operation of the modulator/encoder 38 of the transmitter apparatus. The antenna 30 transmits the amplified signals into air.

While the invention has been shown and described with respect to the embodiments, it will be understood by those skilled in the art that various changes and modification may be made without departing from the scope of the invention as defined in the following claims.

What is claimed is:

1. A communication method using statistical multiplexing in which pre-determined hopping patterns are respectively allocated to two or more users who communicate with a base station using orthogonal resources, the communication method comprising:
receiving a transmission signal transmitted using the orthogonal resources; and
acquiring data from the received transmission signal,
wherein each of the users belongs to one of two or more groups and the pre-determined hopping patterns are allocated to prevent collision between the users belonging to the same group.

2. The communication method of claim 1, wherein the data are acquired based on pilot signals in the transmission signal, wherein the pilot signals are contained in the transmission signal to prevent the groups from colliding with each other.

3. The communication method of claim 2, wherein the pilot signals are transmitted from different resource elements in every group.

4. The communication method of claim 1, further comprising:
determining a group to which a user who has transmitted the transmission signals belongs by detecting pilot signals within the transmission signal; and
determining a user who belongs to the determined group and has transmitted the transmission signal.

5. The communication method of claim 4, wherein the user, who has transmitted the transmission signals, in the determined group is determined based on the pre-determined hopping patterns.

6. The communication method of claim 4, wherein, said determining the group includes determining whether the pilot signals exist or not based on the intensity of the pilot signals.

7. The communication method of claim 1, further comprising:
determining active users by detecting an identification signal, which is allocated to the user, contained in the transmission signals; and
determining a user who has transmitted the transmission signals, among the active users.

8. The communication method of claim 7, wherein the identification signal is assigned as an orthogonal code.

9. The communication method of claim 7, wherein the identification signal is included in the overhead of the transmission signal.

10. The communication method of claim 1, wherein the number of the groups is determined according to types of services communicated by the transmission signal.

11. The communication method of claim 10, wherein the groups are divided according to types of the services or each of the groups includes various types of the services.

12. The communication method of claim 11, wherein the users are distributed in every group in consideration of a balance of traffic load between the groups.

13. A communication apparatus for performing the communication method of claim 1.

14. A communication method using statistical multiplexing in which pre-determined hopping patterns are respectively allocated to two or more users who communicate with a base station using orthogonal resources, the communication method comprising:
determining the orthogonal resources to be used depending on the pre-determined hopping patterns;
determining pilot signals to be allocated to the users; and
transmitting transmission signals including the pilot signals using the determined orthogonal resources,
wherein each of the users belongs to one of two or more groups and the pre-determined hopping patterns are allocated to prevent collision between the users belonging to the same group.

15. The communication method of claim 14, wherein the pilot signals are contained in the transmission signal to prevent the groups from colliding with each other.

16. The communication method of claim 14, wherein the pilot signals are transmitted through different resource elements in every group.

17. The communication method of claim 14, wherein the transmission signals further include identification signals allocated to the users.

18. The communication method of claim 17, wherein the identification signals are assigned as orthogonal codes.

19. The communication method of claim 17, wherein the identification signals are contained in the overheads of the transmission signals.

20. The communication method of claim 14, wherein the number of the groups is determined according to types of services and traffic load of each service.

21. A communication apparatus for performing the communication method of claim 14.
